(19) United States
(12) Patent Application Publication
(10) Pub. No.: US 2009/0267570 A1
(43) Pub. Date: Oct. 29, 2009

(54) Apparatus for providing boot-up capability signals and associated methods

(75) Inventor: Tommi Paunonen, Pirkkala (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/150,595

(22) Filed: Apr. 28, 2008

(51) Int. Cl. H02J 7/00; G06F 15/177

(52) U.S. Cl. 320/150; 320/137; 713/2

(57) ABSTRACT

An apparatus for providing a boot-up capability signal for a portable electronic device, the apparatus configured to determine an amount of charge provided to a battery of the device by a charging process, based around one or more powering events, in order to provide for the boot-up capability signal.

### TECHNICAL FIELD

The present invention relates to the field of apparatus for providing boot-up capability signalling for a portable electronic device.

In certain circumstances, these electronic devices may be portable electronic devices, which may or may not be hand-held in use (although they may be placed in a cradle in use). Such hand-portable electronic devices include so-called Personal Digital Assistants (PDAs).

Such portable electronic devices may provide one or more audio/text/video communication functions (e.g. telecommunication, videocommunication, and/or text transmission (Short Message Service (SMS)/Multimedia Message Service (MMS)/emailing) functions), interactive/non-interactive viewing functions (e.g. web-browsing, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Portable electronic devices, such as mobile telephone comprising batteries, often require a significant amount more power during boot-up than is required after the device is operational. Such devices can require in the order of 400 mA to boot-up, for example. While, during normal operation (i.e. after boot-up has been completed), software can be initialised that reduces this current requirement (e.g. to 20 mA). Modern charging apparatus, such as USB charging apparatus, can often limit their charging current to in the region of 100 mA.

Therefore, there is a requirement, when a battery of a device is being charged (e.g. after it has been fully discharged), to ensure that the battery is sufficiently pre-charged, so as to be able to cope with the current requirements of the boot-up sequence of the device, prior to the said sequence being initiated. If the device fails to boot-up, or initiates then fails as a result of insufficient battery power, then this results in an unsatisfying, and unnecessary wait for the user. In some cases, this can cause a delay in being able to make emergency calls, and the like.

Additionally, variations in battery characteristics due to ambient temperature and degradation caused by aging make it difficult to ensure proper device boot-up sequences occur over the lifetime of a battery/device.

The listing or discussion of a prior-published document or any background in this specification should not necessarily be taken as an acknowledgement that the document or background is part of the state of the art or is common general knowledge. One or more aspects/embodiments of the present invention may or may not address one or more of the background issues.

### SUMMARY

According to a first aspect of the present invention there is provided an apparatus for providing a boot-up capability signal for a portable electronic device, the apparatus configured to determine an amount of charge provided to a battery of the device by a charging process, based around one or more powering events, in order to provide for the boot-up capability signal.

Such an apparatus may be able to provide a boot-up capability signal, such that a portable electronic device (e.g. a mobile telephone, or the like), is able to boot-up after there is sufficient electrical charge in a battery to allow the device to successfully boot-up.

The apparatus may be configured to determine the amount of charge provided to the battery from a charging initiation powering event. The charging initiation powering event may be the time at which a connection of a power supplying charger apparatus (e.g. portable electronic device charger) to the apparatus/device is made. The charging initiation event may be the time at which power starts being supplied to the apparatus/device. The charging initiation event may be an internal event, for example, a scheduled powering event. The apparatus may be configured to determine the amount of charge provided to the battery from a boot-up powering event (e.g. a power on actuation by a user).

Such an apparatus may ensure that a device has sufficient battery power to provide for boot-up, when the battery is being charged, prior to in a boot-up sequence being initiated. Such an apparatus may be able to be used to configure a device such that the minimum time is required between a powering event (e.g. a power on actuation by a user/charging initiation) of a device, and subsequent boot-up, when the battery is flat and being charged.

The apparatus may be configured to determine (e.g. measure, measure and calculate) the level of current provided to the battery over a particular period of time associated with the powering event to determine the amount of charge provided to the battery. The particular period of time may be based on the time of a powering event (e.g. around the beginning of a powering event, such as the start of a powering event; a few moments, such as a few seconds, after a powering event has initiated, etc.).

The apparatus may be configured to determine the level of current provided to the battery over a particular period of time associated with the powering event to determine the amount of charge provided to the battery, and wherein the apparatus is additionally configured to determine the corresponding level of voltage supplied to the battery to determine the power supplied to the battery, such that the amount of energy provided to the battery over the particular period of time associated with the powering event can be determined.

The apparatus may be configured to determine (e.g. measure, measure and calculate) at least one instantaneous current level provided to the battery, based around the powering event, and use the instantaneous current(s) and at least one non-measured particular period of time, to determine the amount of charge provided to a battery.

The apparatus may be configured to determine the instantaneous current from time to time (e.g. periodically, aperiodically) over at least one period of time, which may be measured or non-measured, to determine the amount of charge provided to a battery. This may provide a plurality of instantaneous current levels. The apparatus may use the mean/median values of the instantaneous current levels.

The apparatus may be configured to measure at least one instantaneous current level provided to the battery, based around the powering event, and integrate this instantaneous current over at least one non-measured particular period of time, to determine the amount of charge provided to a battery.

The apparatus may be configured to additionally determine the corresponding battery voltage to provide for the boot-up capability signal. Determining the battery voltage may be by measuring the battery voltage, which may be directly or indirectly. The average (e.g. mean, median) battery voltage may be determined over a particular time (e.g. from around the beginning of a powering event, such as at the start of a power event to some predetermined later time; or after few moments, such as a few seconds, from the instigation of a powering event to some predetermined later time, etc.), which may be a measured time or a non-measured time.

The apparatus may be configured to determine the battery voltage at a particular time (e.g. at around the beginning of a powering event, such as at the start of a power event; or at few moments, such as a few seconds, after the instigation of a powering event)

The apparatus may be configured to use the boot-up capability signal and a criterion to provide for control of boot-up of the portable electronic device. The apparatus may be configured to use the boot-up capability signal and compare this with a criterion to provide for control of boot-up of the portable electronic device.

The criterion may be a particular amount of charge. The criterion may be a particular voltage level and a particular amount of charge. The criterion may be a particular voltage level, or a different particular voltage level and particular amount of charge. The criterion may be a particular voltage level, or a lower particular voltage level and particular amount of charge (e.g. a particular current provided for a particular time)

The apparatus may be configured to determine a temperature to provide for the boot-up capability signal/criterion. The apparatus may be configured to determine one of the ambient temperature and the battery temperature, to provide for the boot-up capability signal/criterion.

The apparatus may be configured to use the temperature to modify the boot-up capability signal. The apparatus may be configured to use the temperature to modify the criterion.

The apparatus may comprise circuitry, configured to measure the level of current provided to the battery over a particular period of time, such as a measured period of time, associated with the powering event to determine the amount of charge provided to the battery.

The circuitry may comprise a measurer to determine the amount of charge, to provide for the boot-up capability signal. The measurer may comprise an ammeter, which may be solid-state.

The circuitry may additionally comprise a controller configured to receive the boot-up capability signal. The controller may be configured to use the boot-up capability signal with a particular criterion to provide for control of boot-up of the portable electronic device.

The circuitry may comprise a processor to determine the amount of charge provided to a battery and to provide for the boot-up capability signal and to provide for control of boot-up of the portable electronic device. The processor may be an application specific integrated circuit (ASIC), field programmable gate array (FPGA), microcontroller, programmable intelligent computer (PIC), or the like.

The circuitry may be further configured determine (e.g. measure, measure and calculate) the battery voltage to provide for the boot-up capability signal.

The circuitry may be further configured to determine a temperature to provide for the boot-up capability signal and/or criterion. The circuitry may be configured to determine one of the ambient temperature, and the battery temperature, to provide for the boot-up capability signal.

The apparatus may be a module for a portable electronic device.

The apparatus may further comprise a processor, configured to receive power from the battery, and to receive a control boot up signal from the controller, so as to provide for boot-up of a portable electronic device.

The controller may be configured to delay boot-up of the portable electronic device, until receipt of a boot-up capability signal. The received boot-up signal may be at least one of: an affirmative signal and a negative signal.

The controller may be configured to delay boot-up of the portable electronic device, until a received boot-up capability signal satisfies a predetermined criterion. The controller may be configured to compare the boot-up capability signal with a criterion, to provide for control of boot-up of a portable electronic device.

According to a second aspect there is provided a portable electronic device comprising the apparatus according to the first aspect.

The portable electronic device may be one of: a mobile phone; Personal Digital Assistant; MP3 player; charging apparatus for a portable electronic apparatus; camera; multimedia player.

According to a third aspect there is provided a charging apparatus for a portable electronic device, the charging apparatus comprising the apparatus according the first aspect.

The charging apparatus may be a portable electronic device charger. The charging apparatus may be with a USB cable/connector (e.g. a cable/connector for connection between a charger and a device). The charging apparatus may be a further device, such as a further portable electronic device, or an electronic device (e.g. PC, or the like). The charging apparatus may be an interface for a device and a charger (e.g. an adapter for a charger/device).

According to a fourth aspect there is provided a method for providing a boot-up capability signal, the method comprising determining the amount of charge provided to a battery of the device by a charging process, based around one or more powering events to provide for the boot-up capability signal.

The method may additionally comprise determining the corresponding battery voltage to provide for the boot-up capability signal.

The method may additionally comprise determining a temperature to provide for the boot-up capability signal.

According to fifth aspect there is provided a computer program, storable on a carrier, the computer program comprising computer code to determine the amount of charge provided to a battery of the device by a charging process, based around one or more powering events, to provide for the boot-up capability signal.

According to a sixth aspect there is provided a means for providing a boot-up capability signal, the means comprising a means for determining the amount of charge provided to a means for storing power of the device by a charging process, based around one or more powering events, to provide for the boot-up capability signal.

The present invention includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 shows a portable electronic device for background understanding;

FIG. 2a shows an embodiment comprising a measurer;

FIG. 2b shows an embodiment comprising power management circuitry;

FIG. 3 shows an embodiment additionally comprising a controller;

FIG. 4a shows an embodiment comprising a temperature monitor;

FIG. 4b shows another embodiment comprising a temperature monitor;

FIG. 5 shows an embodiment with a charger/adapter; and

FIG. 6 shows a flow chart of providing for a boot-up capability signal.

### DESCRIPTION OF SPECIFIC EMBODIMENTS

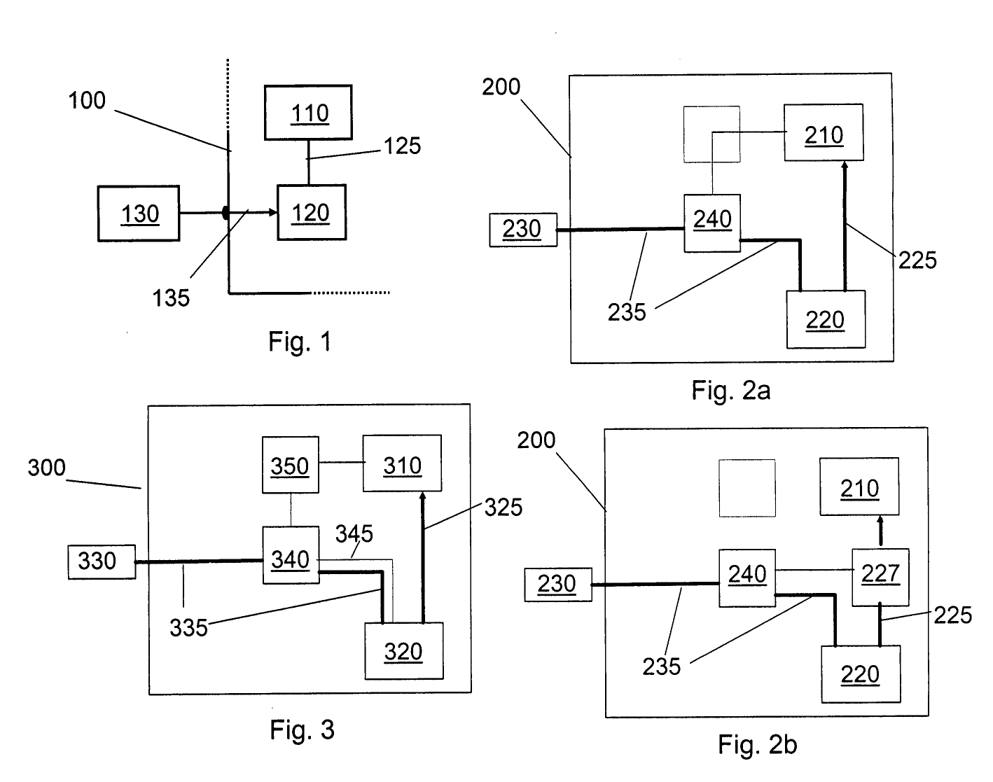

FIG. 1 shows a portable electronic device 100 for background understanding, comprising a processor 110 and a battery 120. The battery 120 is in communication with the processor 110, and is configured to supply the processor 110 with electrical power to power the device 100, in a known manner. Further features of the portable electronic device 100, such as a display, user input interface, etc. are omitted for clarity.

Here, the battery 120 is shown to be additionally in communication with a charging apparatus 130, such as a mains charger. The charger 130/device 100 are configured such that electrical power can be supplied to the battery 120. Here, electrical power is supplied to the battery via a charging path 135. Electrical power is supplied from the battery 120 to the processor 130, via a supply path 125.

In use, and when the battery 120 has been discharged, such as fully discharged (e.g. to zero volts, or to below a minimum which allows for processor 110 operation (i.e. normal running operation)), the charger 130 is able to provide electrical power to recharge the battery 120, via the charging path 135. When the battery 120 is being charged from a fully discharged state, for example, and a boot-up sequence is initiated during this charging process, it can be that the power required by the processor (and possible other components) exceeds the suppliable power that is stored by the battery. In such cases, a boot-up sequence may fail to initiate, or initiate but fail to complete.

FIG. 2a shows an embodiment of the present invention, in which there is provided a portable electronic device 200 comprising a processor 210, and a battery 220. The battery 220 is configured to provide electrical power to the processor 210, via a supply path 225. Here, there is also shown a charger 230, in communication with the device 200, via a charging path 235. The device 200/charger 230 are configured such that battery 220 can be charged.

The device 200 further comprises an apparatus for providing a boot-up capability signal, which in the present embodiment comprises a measurer 240. In the present embodiment the measurer 240 is in communication with the processor 210, and is configured to observe the amount of charge provided to the battery during the charging process, based around one or more powering events. In the present embodiment the powering event is when the battery begins to charge (e.g. when the charger 230 is connected to the device 200). That is, that the measurer 240 is configured to measure the amount of charge provided along the charging path 235 from that particular event.

In alternative embodiments this need not be the case, and the powering event may be when the battery is discharged (e.g. fully discharged, or discharged to a particular voltage level, such as the voltage level at which the processor 210 can operate during normal running operation, etc.), or when a boot-up sequence is requested (e.g. by a user) or the like. In such an arrangement the processor 210 may be configured to communicate to the measurer 240 to initiate determination of the amount of charge provided to the battery 220.

In the present embodiment, the measurer 240 is configured to measure the level of current provided to the battery 220. The measurer 240 is further configured to determine a particular time associated with that level of current, the level of current/period of time corresponding to the amount of charge to be provided to the battery 220. The measurer 240 is further configured to provide a boot-up capability signal to the processor 210, when it has determined that the battery has been provided with charge over a predetermined criterion (e.g. that the battery has been provided with 20 mAh from the powering event).

In alternative embodiments this need not be the case. The measurer 240 may be configured to determine the amount of charge provided to the battery in a different manner. For example, the measurer 240 may be configured to measure the integral of the provided current over a particular period of time. The measurer 240 may be configured to measure the instantaneous current at particular intervals, in order to determine the amount of charge provided to the battery 220. The measurer 220 may be configured to measure a plurality of instantaneous current to determine the amount of charge provided to the battery 220.

In some embodiments, the measurer 240 may be configured to determine the amount of charge (or current) in addition to determining the level of voltage. In such configurations, the measurer 240 may be configured to determine the amount of energy provided to the battery 220 (e.g. determining the power provided over a particular period of measured/non-measured time).

In some embodiments the measurer 240 may be configured to determine the amount of current in addition to determining the level of voltage supplied to the battery. In such configurations, the measurer 240 may be configured to determine the amount of power provided to the battery 220. The amount of energy may be determined by evaluating the power provided over a particular period of measured/non-measured time. A skilled reader will appreciate that such an arrangement is, in effect, measuring the amount of charge provided over a period of time at a voltage.

In further embodiments, the boot-up capability signal may provide the period of time, based upon the measured level of current, for providing a predetermined amount of charge/energy to the battery 220. In such an arrangement the processor 210 may be configured to delay boot-up by that particular period of time.

In use, and when the battery 220 has been discharged, such as fully discharged (e.g. to zero volts, or another voltage level, which in some cases may be defined as fully discharged, such as a voltage below that required for normal running of the processor)), the charger 230 is able to provide electrical power to recharge the battery 220. The measurer 240 is configured to observe the level of current provided to the battery 220 from the instance that charging begins. When the measurer 240 has determined (e.g. based on the level of current and time of supply) that the battery 220 has been provided with charge over a predetermined criterion (e.g. in excess of that required by a boot up sequence), the measurer 240 provides the boot-up capability signal to the processor 210. The processor 210 is configured not to boot-up, unless it has received the boot-up capability signal from the measurer 240. In this arrangement, a boot-up sequence is not likely to fail to initiate, or initiate but fail to complete, due to lack of power stored in the battery.

It will readily be appreciated by the skilled reader that the criterion may be the minimum amount of power required in order to provide for boot-up of the processor 210/device 200. Alternatively, the criterion may be some other value, such as higher that the minimum amount of power required in order to provide for boot-up of the processor 210/device 200. Such an arrangement may account for losses in the device 200 (e.g. heating losses, charge storage losses, losses attributed to powering of the measurer 240 itself, etc.).

A skilled reader will also appreciate that while the measurer 240 is shown distinctly here, in alternative embodiments it may form part of the processor 210 (e.g. provided by the same apparatus/circuitry). Such an arrangement may occur when the processor 210 is provided by an Application Specific Integrated Circuit (ASIC), Field Programmable Gate Array (FPGA), or the like. Similarly it will readily be appreciated that the measurer 240 may be powered by the battery 220, or by the charger 230. Such an arrangement may allow for the measurer 240 to operate, even if the battery 220 is fully discharged. In the arrangement in which the measurer 240 is powered by the battery, the measurer may be unable to provide the boot-up signal when the measurer 240 is not receiving power from the charger 230.

It will be appreciated that in some embodiments, the battery 220 may be configured to provide electrical power to the processor 210, via a supply path 225, which includes power management circuitry 227 (e.g. regulators, etc.). FIG. 2b shows such an arrangement. In this exemplary configuration, the measurer 240 is configured to provide the boot-up capability signal to the power management circuitry 227 to allow for boot-up. In other embodiments, the measurer 240 may be configured to provide the boot-up capability signal to the processor 210 to allow for boot-up, as described above.

FIG. 3 shows a further embodiment of the present invention, where there is provided a portable electronic device 300, comprising a processor 310 and a battery 320, in a similar manner to that described above in which the battery is configured to supply power via a supply path 325. Again a charger 330 is shown, which is configured to provide electrical power to the battery 320 via a charging path 335. In this embodiment the device 300 is provided with a measurer 340 and a controller 350.

The measurer 340 is configured to measure the level of current provided to the battery 320 over a period of time, in order to ascertain the amount of charge provided to the battery 320. In addition the measurer 340 is configured to measure the voltage of the battery 320. It will readily be appreciated that this may be achieved directly by measuring the voltage by a voltage path 345 (as shown), or in other embodiments indirectly such a measuring the voltage of the battery from the charging path 335, or the supply path 325 (e.g. measuring the voltage at the processor 310).

In this embodiment, the measurer 340 is further configured to provide a boot-up capability signal to the controller 350. Here, the boot-up capability signal relates to the amount of charge provided to the battery 320, as well as the battery 320 voltage.

In this embodiment, the controller 350 is configured to determine if the boot-up capability signal satisfies a predetermined criterion. The controller 350 is further in communication with the processor 310, and is configured to communicate a controller boot-up signal to the processor 310, when the controller has determined that the boot-up capability signal satisfies the predetermined criterion.

In the present embodiment, the controller 350 is configured to provide a controller boot-up signal when it has determined that either the voltage of the battery 320 is over a particular level (e.g. 3.6 V), or that the battery 320 has received in excess of particular charge (e.g. 20 mAh) during a charging process, based around a powering event (e.g. that the battery has be provided with 20 mAh, since is has begun charging, or since a user of the device has requesting a boot-up).

In alternative embodiments the controller 350 may be configured to provide a controller boot-up signal based on different criterion, such as when it has determined that either the voltage of the battery 320 is over a first particular level (e.g. 3.6 V), or that the battery 320 has received in excess of particular charge (e.g. 20 mAh) and that the battery voltage is over a second particular level (e.g. 3.3 V).

In use, and when the battery 320 has been discharged, such as fully discharged (e.g. to zero volts), the charger 330 is able to provide electrical power to recharge the battery 320. The measurer 340 observes the level of current provided to the battery 320 from around the instance that charging begins (e.g. at the time that charging begins). The measurer 340 observes also the level of voltage of the battery 320, and communicates both these measured parameters to the controller 350 as the boot-up capability signal.

When the controller 350 has determined (e.g. based on voltage level/level of current) that the battery 320 has power (at a determined time) in excess of that required by the boot up sequence, the controller 350 provides the controller boot-up signal to the processor 310. The processor 310 is configured not to boot-up, unless it has received the controller boot-up signal from the controller 350. In this arrangement, a boot-up sequence is not likely to fail to initiate, or initiate but fail to complete, due to lack of power stored in the battery 320.

It will readily be appreciated that as the voltage is observed in addition to the amount of charge provided, that the controller 350 ascertains that there is sufficient power stored in the battery 320, without requiring excess time than is required between a powering event and a boot-up sequence being initiated. It will also be readily appreciated that in such an arrangement, the portable electronic device 300 is able to boot-up when the battery 320 is partially charged at the beginning of the powering event, without the requirement of providing charge (e.g. a voltage in excess of a pre-determined criterion being indicative that the battery 320 has the capability to supply power for the boot-up sequence).

Additionally, as the voltage is measured, the apparatus can determine if the battery is receiving/storing the provided charge. A skilled person will readily appreciate that such an arrangement may be able to take account of the ability of a battery 320 to store charge, later in its life cycle.

As skilled reader will also appreciate that in the above embodiment that while the processor 310, controller 350, and measurer 340 are shown as distinct (e.g. discrete components), in alternative embodiments that need not be the case. The controller 350/measurer 340 may be provided by a single apparatus/circuitry (e.g. in a similar manner to the first embodiment), and/or may be provided as part of the processor 310 (e.g. using an ASIC, or the like).

In addition, it will be appreciated that as the voltage is being measured that the measurer 340 may be configured to provide the boot-up capability signal if it satisfies a predetermined criterion, in which the predetermined criterion relates to the power/energy being provided.

In such an embodiment, the controller 350 may be configured to provide a controller boot-up signal when it has determined that the battery 320 has received in excess of particular energy (e.g. 50 mWh) during a charging process, based around a powering event (e.g. that the battery 320 has be provided with 50 mWh, since is has begun charging, or since a user of the device has requesting a boot-up).

In alternative embodiments the controller 350 may be configured to provide a controller boot-up signal based on different criterion, such as when it has determined that either the voltage of the battery 320 is over a first particular level (e.g. 3.6 V), or that the battery 320 has received in excess of particular energy (e.g. 50 mWh) and that the battery voltage is over a second particular level (e.g. 3.3 V).

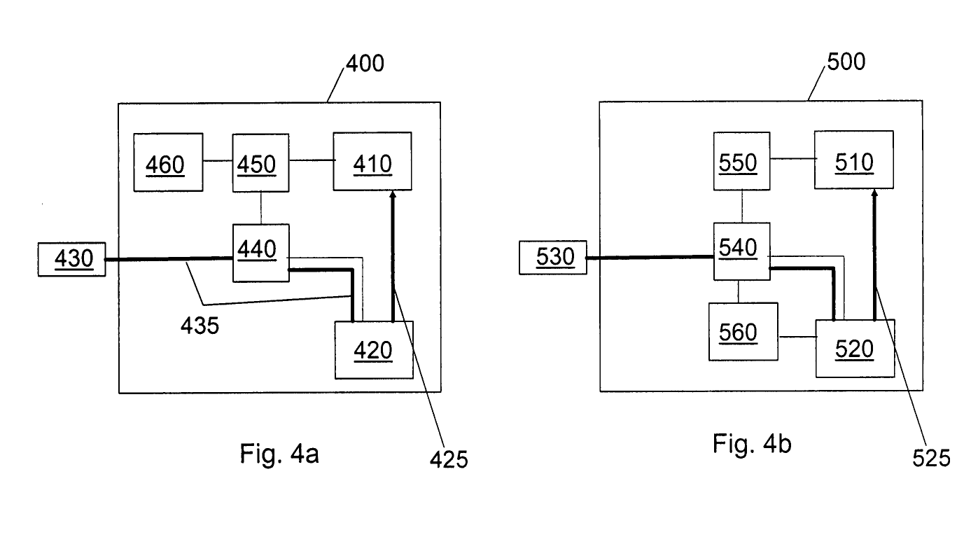

FIG. 4a shows a further embodiment of the present invention. Here, a portable electronic device 400 comprises a processor 410, a battery 420, a measurer 440, and a controller 450, in a similar manner to that described above. Again, a charger 430 is shown in communication with, and configured to supply power to, the battery 420 via a charging path 435. The battery is configured to supply electrical power to the processor 410.

In this embodiment, measurer 440 is again configured to measure the level of current provided to the battery 420 over a period of time, in order to ascertain the amount of charge provided to the battery 420. Here, the measurer 440 is configured to observe the time varying level of current provided to the battery 420 from the instance that the device experiences a boot-up powering event (e.g. a user request for boot-up, such as actuation of an “on” key, or the like). Again, the measurer 440 additionally is configured to measure the voltage of the battery 420 and to provide a boot-up capability signal to the controller 450.

In this embodiment, the device 400 further comprises a temperature monitor 460, configured to determine the ambient temperature of the device 400. Here, the temperature monitor 460 is configured to provide a temperature signal to the controller 450.

The controller 450 is configured to determine if the boot-up capability signal satisfies a predetermined criterion, in a similar manner to that described above. However, in this embodiment, the controller 450 is configured to establish the particular criterion based upon the ambient temperature of the device 400.

The controller 450 is again in communication with the processor 410, and is configured to communicate a controller boot-up signal to the processor 410, when the controller 450 has determined that the boot-up capability signal satisfies the predetermined criterion at that particular temperature.

In the present embodiment, the controller 450 is configured to provide a controller boot-up signal when it has determined that, at normal operating temperatures (e.g. 5° C. to 30° C., room temperature, etc) either that the voltage of the battery 420 is over a first particular level (e.g. 3.6 V), or that the battery 420 has been provided in excess of a particular charge (e.g. 20 mAh), during a charging process, from around the time of the boot-up powering event (e.g. from the time that the “on” button was pressed by the user, the time that the charging began (e.g. charger connected, etc.), or the like) and that the battery voltage is in excess of a second particular level (e.g. 3.3 V).

At different temperatures (e.g. higher temperatures, when the internal resistance of the battery might be increased, and/or lower temperatures when the performance of the batteries chemistries might be reduced), the controller 450 is configured to alter the criterion, such as increasing the amount of charge required to have been provided to the battery 440 before providing the controller boot-up signal to provide for the processor 410 to boot-up.

In use, and when the battery 420 has been discharged, such as fully discharged (e.g. to zero volts), the charger 430 is able to provide electrical power to recharge the battery 420. The measurer 440 observes the level of current provided to the battery 420 from around the time (e.g. at the instance) that a boot-up request is made (e.g. the pressing, by a user, of an “on” button). The measurer 440 also observes the level of voltage of the battery 420, and communicates both these measured parameters to the controller 450 as the boot-up capability signal. Additionally, the controller receives a temperature signal from the temperature monitor 460, indicative of the ambient temperature or the device 400/device surroundings.

The controller 450 determines (e.g. based on voltage level/amount of charge provided/temperature) if the battery 420 has power in excess of that required by the boot-up sequence. If so, the controller 450 provides the controller boot-up signal to the processor 410. The processor 410 is configured not to boot-up, unless it has received the controller boot-up signal from the controller 450. In this arrangement, a boot-up sequence is not likely to fail to initiate, or initiate but fail to complete, due to lack of power stored in the battery 420.

It will readily be appreciated that due to the fact that the temperature is observed in addition to the amount of charge/voltage, that the controller 450 can ascertain that there is sufficient power stored in the battery based on particular temperature. Therefore, in such arrangements, the device 400 requires only the minimum time to supply charge from a power event, based on the following parameters: charge supplied, charge potentially stored (e.g. indirectly through present voltage), present charge status (through voltage) and thermal variations (effects of temperature).

FIG. 4b shows a further exemplary embodiment of a device 500, similar to that described in relation to FIG. 4a, comprising a processor 510, battery 520, a measurer 540, a controller 550, and a temperature monitor 560. Again, a charger 530 is shown in communication with, and configured to supply power to, the battery 520.

In this embodiment, the temperature monitor 560 is configured to determine the temperature of the battery 520 of the device 500. Here, the temperature monitor 560 is configured to provide a temperature signal to the measurer 540.

The measurer 540 is configured to change the boot-up capability signal, based upon the temperature of the battery 520. The controller 550 is configured to determine if the boot-up capability signal satisfies a predetermined criterion, in a similar manner to that described in the embodiment in relation to FIG. 3.

In use, the measurer 540 is configured to alter the boot-up capability signal, so as to adjust for the battery's 520 temperature dependent properties. For example, the boot-up capability signal may state to the controller 550 that a different charge, such as less charge, has been provided to the battery than has actually be provided, when the temperature is outside (e.g. below, above) a particular temperature range. Alternatively, or additionally the boot-up capability signal may state to the controller 550 that the battery 520 is at a different voltage, such as a lower voltage, than the battery 520 actually is, when the temperature is outside a particular temperature range.

The controller 550, upon receipt of a boot-up capability signal, is configured to provide for control of the boot-up of the processor 510 by comparing the boot-up capability signal with a particular criterion, in a similar manner as above.

A skilled reader will readily appreciate that the temperature monitors 460, 560 as described in both embodiments in FIG. 4 may be used to measure the ambient temperature and/or battery temperature, and/or any other temperature associated with the device 400, 500.

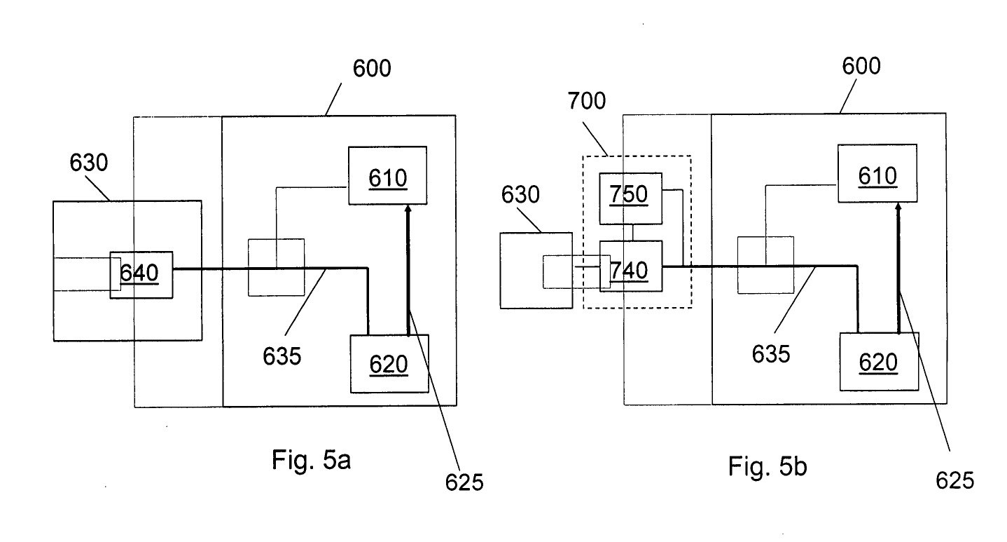

FIG. 5a shows a further embodiment, in which a portable electronic device 600 comprises a processor 610 and a battery 620, in a similar manner to that previously described (e.g. with a supply path 625, etc.). A charger 630 is configured to be able to communicate with, and to provide power to, the battery 620 of the device 600, via a charging path 635. In this embodiment, the charger 630 further comprises a measurer 640. The device 600/charger 630 are configured such that, when connected, the measurer 640 is in communication with the processor 610 so as to be able to provide a boot-up capability signal.

A skilled reader will readily appreciate that a charger may provide such dual connectivity (e.g. using a USB charger: VBUS line to charge, and +D −D to communicate the boot-up capability signal). Alternatively, the boot-up capability signal may be provided on a single power line (in addition to a charge current), for example in a modulated manner. In such an arrangement, the modulated boot-up capability signal may be capacitivly coupled to the processor 610 in the device 600, or the like.

In use, the measurer 640 is able to determine the amount of charge provided to the battery 620, in a similar manner to that described above. Therefore, in this embodiment, the charger 630 is able to provide for a boot-up capability signal to the processor 610. It will readily be appreciated that in some embodiments the charger may additionally comprise a controller/temperature monitor, and/or those features may be provided at the device 600. In a similar manner the measurer 640 may be configured to measure the voltage of the battery 620, etc.

In some embodiments, the measurer 640 may be provided by an interface 700 between a charger 630 and device 600, as is shown in FIG. 5b. Here, the interface 700 comprises a measurer 740 and a controller 750, configured and operable in a similar manner to that described above. A skilled reader will readily appreciated that the charger/interface 600, 700 may be provided additionally with a temperature monitor. In addition, that any of the controller/measurer/temperature monitor may be provided on any of the device/charger. In this embodiment the controller is able to provide a controller boot-up signal to the processor, during a charging process.

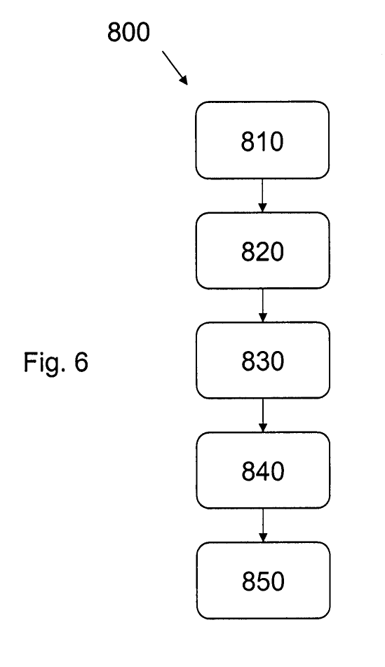

FIG. 6 shows a flow chart 800 of features of an embodiment using an apparatus for providing for a boot-up capability signal. In a first feature 810, a portable electronic device begins a charging process (e.g. connecting a device, such as a mobile phone, to a charger). In a second feature 820, a measurer/controller/processor determines the amount of charge provided to a battery based around a powering event, (e.g. from the time that the charging process begins), and in some embodiments the battery voltage and/or temperature. In a third feature 830 a boot-up sequence is requested (e.g. by the user/external input (e.g. software, GSM signal, etc.)). In a fourth feature 840 the device determines (e.g. the processor) whether or not it can boot-up based upon a boot-up capability signal provided by the measurer/controller/processor. In such an embodiment, the device may be configured to monitor (e.g. constantly monitor) to see if it can boot-up. In a fifth feature 850, the device/processor boots up at around the moment when there is determined to be provided sufficient power stored in the battery to allow boot-up to successfully occur.

It will readily be appreciated that in any of the above embodiments the measurer 240, 340, 440, 540, 640, 740/controller 350, 450, 550, 750/temperature monitor 460, 560 may be powered by the battery 220, 320, 420, 520, 620, or by the charger 230, 330, 430, 530, 630, in a similar manner as described in relation to the embodiment in FIG. 2. In a similar manner, it may be that the battery 220, 320, 420, 520, 620 is configured to provide power to other parts of the device, in addition to the processor. In such arrangement, the apparatus may be configured to determine the net amount of charge being provided to the battery (e.g. by determining the charge being provided to other apparatus, in a similar manner).

It will also be appreciated that any of measurer 240, 340, 440, 540, 640, 740/controller 350, 450, 550, 750/temperature monitor 460, 560 may be provided by different or the same circuitry (e.g. using an ASIC), which may be provided by the processor 210, 310, 410, 510, 610.

Similarly, it will be appreciated to the skilled reader that the device/apparatus and/or other features of particular apparatus may be provided by apparatus/circuitry arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory.

It will be appreciated that the aforementioned circuitry/apparatus/elements may have other functions in addition to the mentioned functions, and that these functions may be performed by the same circuit/apparatus/element.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus for providing a boot-up capability signal for a portable electronic device, the apparatus configured to determine an amount of charge provided to a battery of the device by a charging process, based around one or more powering events, in order to provide for the boot-up capability signal.

2. An apparatus according to claim 1, wherein the apparatus is configured to determine the amount of charge provided to the battery from a charging initiation powering event.

3. An apparatus according to claim 1, wherein the apparatus is configured to determine the amount of charge provided to the battery from a boot-up powering event.

4. An apparatus according to claim 1, wherein the apparatus is configured to determine the level of current provided to the battery over a particular period of time associated with the powering event to determine the amount of charge provided to the battery.

5. An apparatus according to claim 1 wherein the apparatus is configured to determine the level of current provided to the battery over a particular period of time associated with the powering event to determine the amount of charge provided to the battery, and wherein the apparatus is additionally configured to determine the corresponding level of voltage supplied to the battery to determine the power supplied to the battery, such that the amount of energy provided to the battery over the particular period of time associated with the powering event can be determined.

6. An apparatus according to claim 1, wherein the apparatus is configured to determine at least one instantaneous current level provided to the battery, based around the powering event, and integrate this instantaneous current over at least one non-measured particular period of time, to determine the amount of charge provided to a battery.

7. An apparatus according to claim 1, wherein the apparatus is configured to additionally determine the corresponding battery voltage to provide for the boot-up capability signal.

8. An apparatus according to claim 1, wherein the apparatus is configured to use the boot-up capability signal and a criterion to provide for control of boot-up of the portable electronic device.

9. An apparatus according to claim 8, wherein the apparatus is configured to determine a temperature to provide for the boot-up capability signal/criterion.

10. An apparatus according to claim 9, where the apparatus is configured to determine one of the ambient temperature, and the battery temperature, to provide for the boot-up capability signal/criterion.

11. An apparatus according to claim 1, comprising circuitry configured to measure the level of current provided to the battery over a measured particular period of time associated with the powering event to determine the amount of charge provided to the battery.

12. An apparatus according to claim 11, wherein the circuitry comprises a measurer to determine the amount of charge, to provide for the boot-up capability signal.

13. An apparatus according to claim 11, wherein the circuitry comprises a controller configured to receive the boot-up capability signal and use with a particular criterion to provide for control of boot-up of the portable electronic device.

14. An apparatus according to claim 11, wherein the circuitry comprises a processor to determine the amount of charge to provide for the boot-up capability signal and to provide for control of boot-up of the portable electronic device.

15. An apparatus according to claim 11, wherein the circuitry is further configured to determine the battery voltage and a temperature to provide for the boot-up capability signal.

16. An apparatus according to claim 15, wherein the circuitry is configured to determine one of the ambient temperature, and the battery temperature, to provide for the boot-up capability signal.

17. An apparatus according to claim 11, wherein the circuitry is further configured to determine the battery voltage to provide for the boot-up capability signal.

18. An apparatus according to claim 1, wherein the apparatus is a module for a portable electronic device.

19. An apparatus according to claim 13, wherein the apparatus further comprises a processor, configured to receive power from the battery, and to receive a control boot up signal from the controller, so as to provide for boot-up of a portable electronic device.

20. An apparatus according to claim 19, wherein the controller is configured to delay boot-up of the portable electronic device, until receipt of an affirmative boot-up capability signal.

21. An apparatus according to claim 19, wherein the controller is configured to delay boot-up of the portable electronic device, until a received boot-up capability signal satisfies a predetermined criterion.

22. A portable electronic device comprising the apparatus according to claim 1.

23. A portable electronic device according to claim 22, wherein the device is one of: a mobile phone; Personal Digital Assistant; MP3 player; charging apparatus for a portable electronic apparatus; camera; multimedia player.

24. A charging apparatus for a portable electronic device, the charging apparatus comprising the apparatus according to claim 1.

25. A method for providing a boot-up capability signal, the method comprising determining the amount of charge provided to a battery of the device by a charging process, based around one or more powering events to provide for the boot-up capability signal.

26. A method according to claim 25, comprising additionally determining the corresponding battery voltage to provide for the boot-up capability signal.

27. A method according to claim 26, comprising additionally determining a temperature to provide for the boot-up capability signal.

28. A computer readable medium having stored thereon a computer program comprising computer code executable on a computer to determine the amount of charge provided to a battery of the device by a charging process, based around one or more powering events, to provide for a boot-up capability signal.

29. A means for providing a boot-up capability signal, the means comprising a means for determining the amount of charge provided to a means for storing power of the device by a charging process, based around one or more powering events, to provide for the boot-up capability signal.
